(19) United States
(12) Patent Application Publication
(10) Pub. No.: US 2015/0068568 A1
(43) Pub. Date: Mar. 12, 2015

(54) OPENING SPRING FOR MULTIPLE FOLD AUTOMATIC OPEN-CLOSE UNBRELLA

(71) Applicant: Tsun-Zong Wu, New Taipei City (TW)

(72) Inventors: Tsun-Zong WU, New Taipei City (TW); Hsien-Jung CHEN, New Taipei City (TW)

(73) Assignee: Tsun-Zong Wu, New Taipei City (TW)

(21) Appl. No.: 14/025,181

(22) Filed: Sep. 12, 2013

(51) Int. Cl. F03G 1/02; A45B 25/16; F16F 3/04; F03G 1/10; F16F 1/04

(52) U.S. Cl. CPC F03G 1/02; F03G 1/10; F16F 1/047; F16F 3/04; A45B 25/16
USPC 135/22; 267/180; 267/166

(57) ABSTRACT

An opening spring for multiple fold automatic open-close umbrellas is revealed. The opening spring is disposed in a shaft to provide power for extending the shaft while opening the umbrella. The opening spring is formed by a wound wire with a constant wire diameter and having a plurality segments of coils with different outer diameters. A gradually changing part is disposed between two adjacent segments of coils. The coil outer diameter of the gradually changing part is reduced from top to bottom along the axial direction.

### BACKGROUND OF THE INVENTION

The present invention relates to an opening spring for umbrellas, especially to an opening spring for multiple fold automatic open-close umbrellas.

Generally, a multiple fold automatic open-close umbrella includes an opening spring disposed in a shaft to providing power for extending the shaft while opening the umbrella, as shown in FIG. 1. A shaft 100 of a multiple fold automatic open-close umbrella includes an outer tube 101, a middle tube 102 and an inner tube 103 sleeved in each other slidably from outside to inside in turn. An opening spring 200 is formed by spiral coils with a fixed outer diameter. When the opening spring 200 is mounted in the shaft 100, its outer diameter is a bit smaller than an inner diameter of the inner tube 103. The inner diameter of the middle tube 102 and the outer tube 101 is larger than that of the inner tube 103. After being extended, the opening spring 200 in a larger space of the middle tube 102 and the outer tube 101 is easy to distort and this has negative effect on the elastic force of the opening spring 200. Thus the opening spring 200 is unable to work properly and even get locked with other components in the shaft 100. Both effects and service life of the opening spring 200 have been affected.

In order to make the multiple fold automatic open-close umbrella works properly, manufacturers usually increases the strength of the opening spring. But the force required to press and slide the shaft for closing the umbrella is also increased. For the elders and children, the umbrella is difficult to use. Refer to prior arts CN 202635844U, CN 202999585U, CN202774563U, CN202739035U etc., all try to overcome the above shortcomings. The opening spring with the same outer diameter is replaced by two springs with different outer diameters 301, 302. The spring with larger outer diameter 301 and the spring with smaller outer diameter 302 are connected in series and are mounted vertically in a shaft 100. As shown in FIG. 2, a connector 303 is disposed between the two springs 301, 302. However, the two springs 301, 302 are produced respectively and the connector 303 is a new component. Moreover, the two springs 301, 302 are connected to the connector 303 respectively. Thus the structure is more complicated, the processing is more difficult, and the cost is increased. In addition, the number of dead coils of the coil springs 301, 302 is increased in order to connect to the connector 303.

It is learned that a conventional one-part opening spring has a problem of lateral bending. Another conventional opening spring formed by two springs needs to connect the two springs by the connector 303. In order to make the multiple fold automatic open-close umbrella have effects of normal use, easy fold and storage, and easy set-up, whether the opening spring has sufficient compression travel and elastic force should also be considered. Thus there is room for improvement and a need to provide a novel opening spring for multiple fold automatic open-close umbrellas that makes the umbrella use easily and work properly.

### SUMMARY OF THE INVENTION

Therefore it is a primary object of the present invention to provide an opening spring for multiple fold automatic open-close umbrellas formed by a wound wire with a constant diameter and having a plurality of coils. According to the coil outer diameter, the coils are divided into coils are divided into coils are divided into a plurality of segments along the axial direction. The outer diameter of an upper segment of the coils is larger than the outer diameter of a lower segment of coils. A gradually changing part is disposed between two adjacent segments of coils. The coil outer diameter of the gradually changing part is reduced from top to bottom along the axial direction. Thereby the opening spring has simple structure, easy processing and low cost. While closing the umbrella, a smaller force is required to retract the umbrella.

### BRIEF DESCRIPTION OF THE DRAWINGS

FIG. 1 is a cross sectional view of a conventional multiple fold automatic open-close umbrella having an opening spring with a constant outer diameter of an embodiment according to the present invention;

FIG. 2 is a cross sectional view of another conventional multiple fold automatic open-close umbrella having two opening springs with different outer diameters of an embodiment according to the present invention;

FIG. 3 is a side view of an embodiment of an opening spring according to the present invention;

FIG. 4 to FIG. 6 are partial enlarged views of different embodiments of a gradually changing part according to the present invention;

FIG. 7 is a cross section of an embodiment of a 3 fold automatic open-close umbrella in a close state according to the present invention;

FIG. 8 is a cross section of an embodiment of a 3 fold automatic open-close umbrella in an open state according to the present invention;

FIG. 9 is a cross section of an embodiment of a 4 fold automatic open-close umbrella in an open state according to the present invention;

FIG. 10 is a side view of another embodiment of an opening spring having two gradually changing parts according to the present invention;

FIG. 11 is a cross section of a 4 fold automatic open-close umbrella with the embodiment shown in FIG. 10 according to the present invention;

FIG. 12 is a graph showing relationship between force and deformation of a conventional opening spring and an embodiment of the present invention.

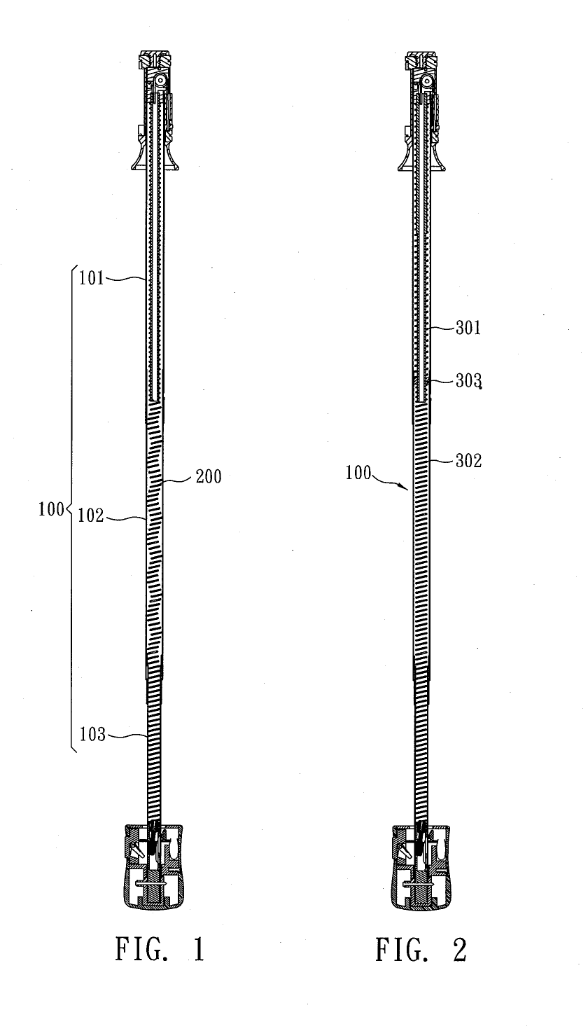

### DETAILED DESCRIPTION OF THE PREFFERED EMBODIMENT

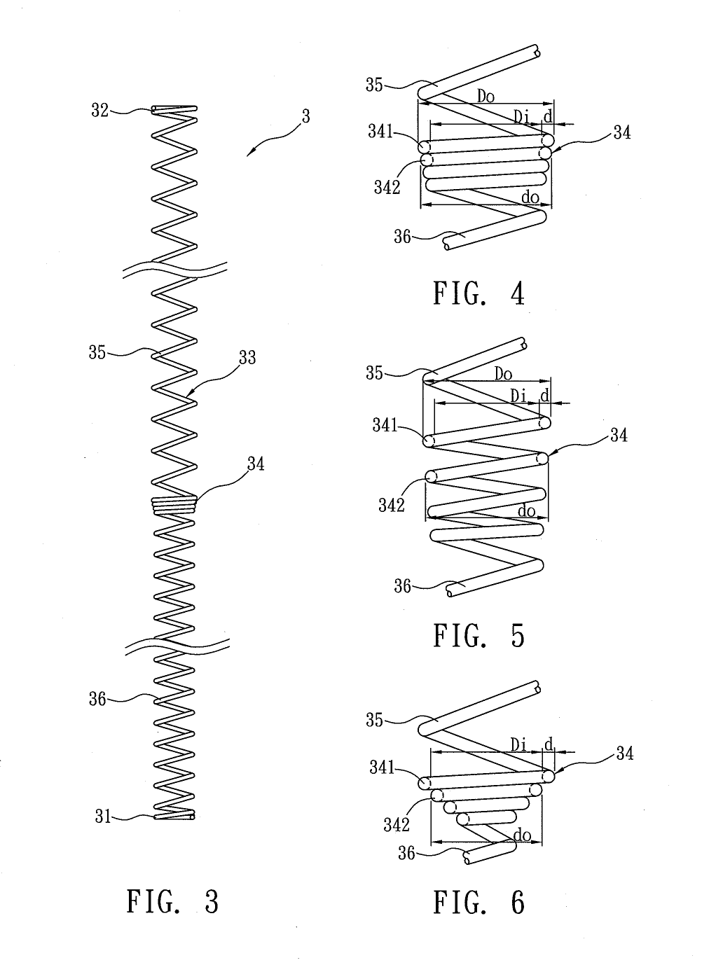

Refer from FIG. 3 to FIG. 11, an opening spring of the present invention is used in a multiple fold automatic opening-closing umbrella. The multiple fold automatic opening-closing umbrella includes a shaft 1, an umbrella rib assembly 2, an opening spring 3, a plurality of closing springs 4 and a control mechanism 5.

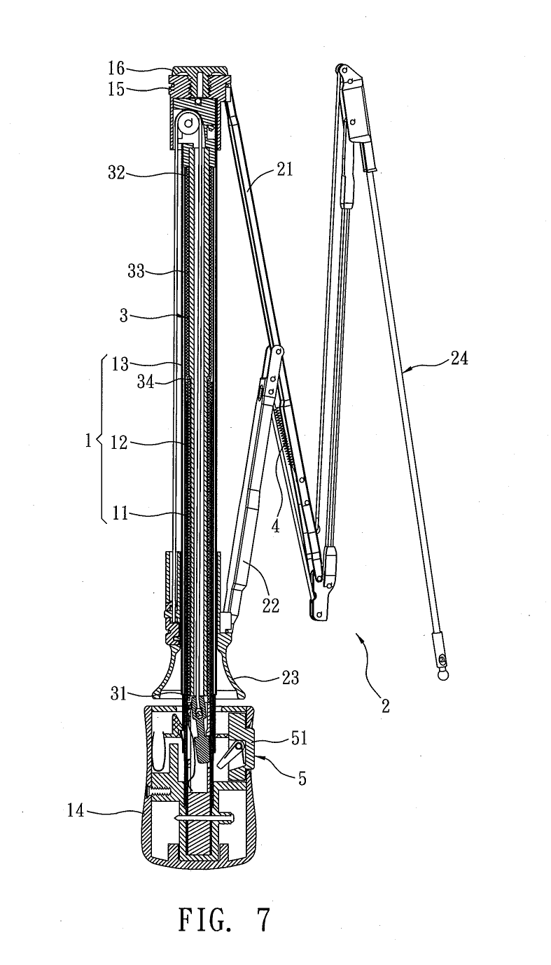

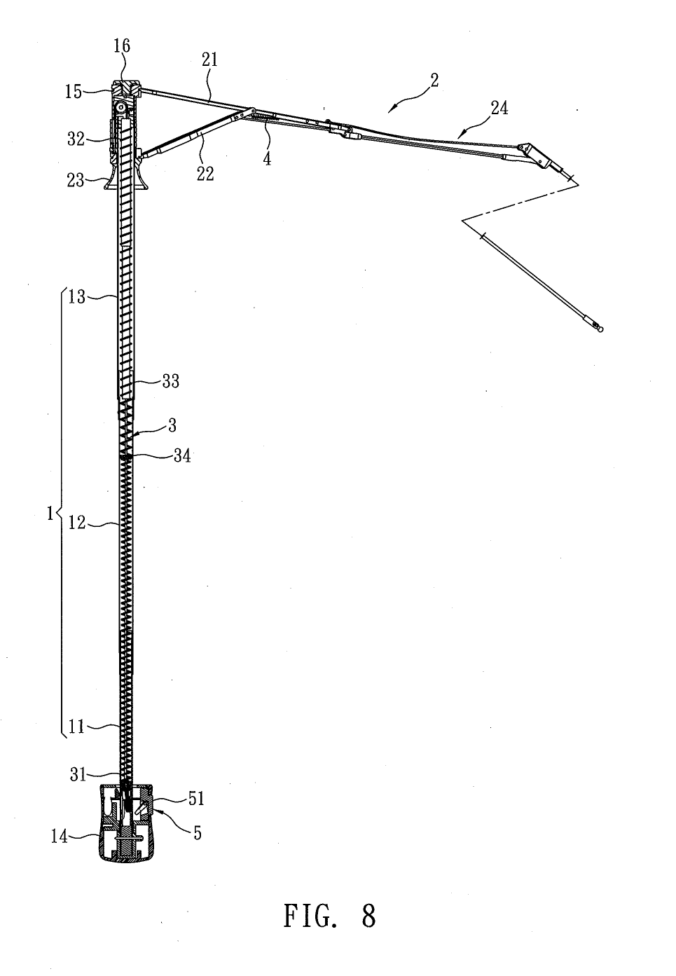

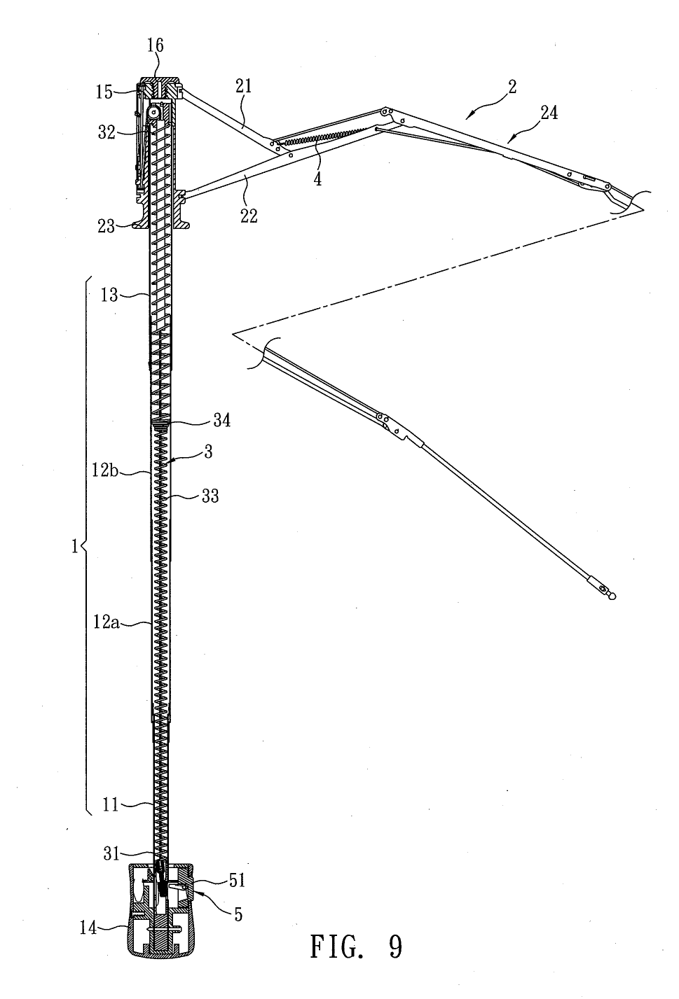

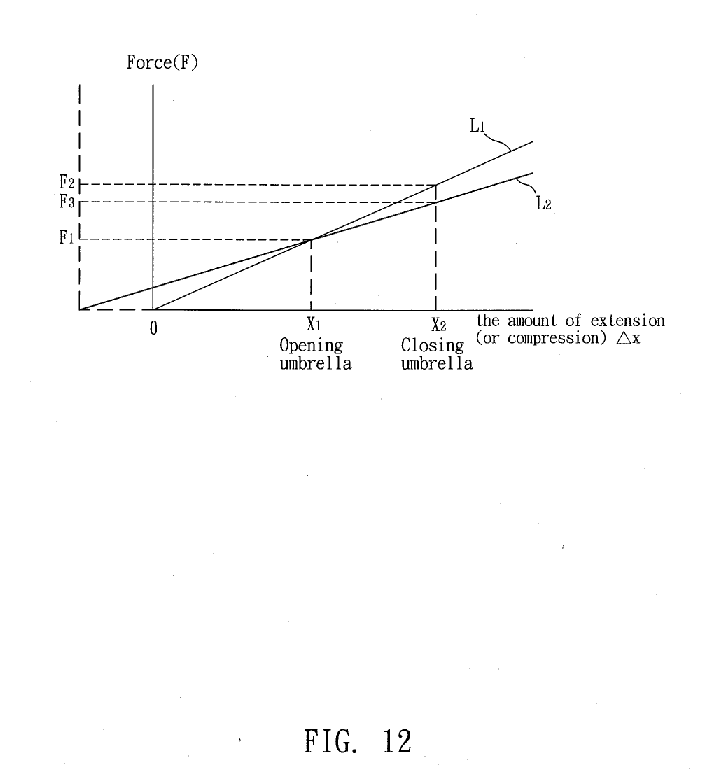

Refer to FIG. 7 and FIG. 8, the shaft 1 consists of an inner tube 11, at least a middle tube 12 and an outer tube 13. An umbrella handle 14 is connected to a bottom end of the inner tube 11 while the middle tube 12 is slid vertically around and engaged with the inner tube 11. Similarly, the outer tube 13 is slid vertically around and engaged with the middle tube 12. A top end of the outer tube 13 is disposed with an upper runner 15. When there is one middle tube 12, the shaft 1 is applied to a 3 fold umbrella as shown in FIG. 7 and FIG. 8. While the number of the middle tube 12 is two, the shaft 1 is used in a 4 fold umbrella as shown in FIG. 9 and FIG. 11. A first middle tube 12a is slid upward around and engaged with the inner tube 11 while a second middle tube 12b is slid upward around and engaged with the first middle tube 12a. Moreover, the opening spring is applied to the 3 fold automatic opening-closing umbrella or 4 fold automatic opening-closing umbrella, as shown in figures, but the fold number of the umbrella is not limited. The opening spring of the present invention can also be modified and applied to other multiple fold automatic opening-closing umbrellas such as 5 fold automatic opening-closing umbrella.

The umbrella rib assembly 2 is composed of a top rib 21, a lower branch rib 22, a lower runner 23, and a plurality of umbrella ribs 24. An inner end of the top rib 21 is pivotally connected to the upper runner 15 of the shaft 1. An inner end of the lower branch rib 22 is pivotally connected to the lower runner 23 so as to be slid around and engaged with the outer tube 13 of the shaft 1 while the other end thereof is pivotally connected to the top rib 21. The umbrella ribs 24 are pivotally connected to one another, the top rib 21 and the lower branch rib 22. The umbrella rib assembly 2 can also be modified according to changes of the umbrella ribs and the fold number of the automatic open-close umbrella.

A bottom end of the opening spring 3 is arranged at and supported by a lower part of the inner tube 11 of the shaft 1 while a top end of the opening spring 3 is disposed on and against the bottom of the upper runner 15 or the top of the outer tube 13.

Each closing spring 4 is disposed between the top rib 21 and the lower branch rib 22 of the umbrella rib assembly 2. The closing spring 4 can also be arranged at other positions of the umbrella rib assembly 2. Elastic energy is stored in the closing spring 4 while the umbrella being opened by the opening spring 3. Then the elastic energy is going to be used for closing the umbrella.

The control mechanism 5 includes a button 51 arranged at the umbrella handle 14. By pressing the button 51 to release the locked state, the lower runner 23, the tubes 13, 12 12a, 12b of the shaft 1, and each umbrella rib of the umbrella rib assembly 2 are extended upward and outward due to elasticity of the opening spring 3 for opening the umbrella. Then press the button 51 again to release the umbrella ribs and tubes from the locking state for closing the umbrella. Next the umbrella handle 14 is pressed toward an umbrella cap 16 to compress the opening spring 3 and elastic energy is stored again for opening the umbrella next time.

Refer from FIG. 3 to FIG. 6, the opening spring 3 is formed by a wounded wire with a constant wire diameter and having a plurality of coils 33. The coils 33 include a plurality of continuous segments with different coil outer diameters axially. The outer diameter of an upper segment of coils is larger than the outer diameter of a lower segment of coils. The pitch of the upper segment of coils is larger than the pitch of the lower segment of coils. A gradually changing part 34 is arranged between two adjacent segments of coils. The gradually changing part 34 includes continuous coils 341, 342 wound inward and downward. The outer diameter of the coils 341, 342 is decreased from top to bottom. As shown in FIG. 4 and FIG. 5, the outer diameter do of the coil 342 is ranging between an inner diameter of the coil 341 Di and an outer diameter Do of the coil 341. Thus while the spring 3 being compressed axially, the coil 342 is axially compressed or axially against the coil 341. As shown in FIG. 6, an outer diameter do of the coil 342 is smaller than the inner diameter Di of the coil 341. While being compressed axially, the coil 342 is passed through the coil 341 axially, without radial interference.

Refer to FIG. 3, FIG. 7 and FIG. 8, when there is only one gradually changing part 34 in the opening spring 3, the opening spring 3 includes an upper spring 35, and a lower spring 36 in turn from top to bottom while the gradually changing part 34 is arranged between the upper spring 35 and the lower spring 36. The top end of the upper spring 35 is against the bottom of the upper runner 15 or the top of the outer tube 13. The bottom end of the upper spring 35 is connected to the top end of the lower spring 36 by the gradually changing part 34 while the bottom end of the lower spring 36 is against the bottom of the inner tube 11.

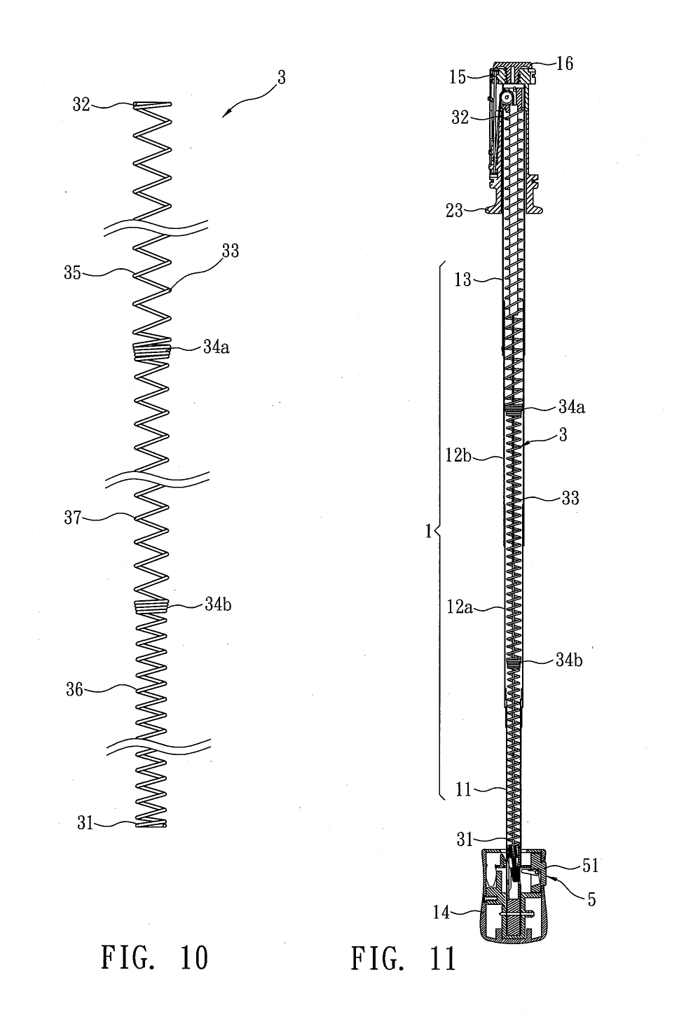

Refer to FIG. 10 and FIG. 11, when there are two gradually changing parts 34 in the opening spring 3, the opening spring 3 includes an upper spring 35, a middle spring 37, and a lower spring 36 in turn from top to bottom. A gradually changing part 34a is arranged between the upper spring 35 and the middle spring 37, and the other gradually changing part 34b is disposed between the middle spring 37 and the lower spring 36. The top end of the upper spring 35 is against the bottom of the upper runner 15 or the top of the outer tube 13. The bottom end of the upper spring 35 is connected to the top end of the middle spring 37 by the gradually changing part 34a while the bottom end of the middle spring 37 is connected to the top end of the lower spring 36 by the gradually changing part 34b. The bottom of the lower spring 36 is against the bottom of the inner tube 11. The coil outer diameter of the gradually changing part 34a is larger than the coil outer diameter of the gradually changing part 34b.

Refer to FIG. 7 and FIG. 8, when the opening spring 3 with one gradually changing part 34 is assembled with the shaft 1 of a 3 fold automatic open-close umbrella having one middle tube 12, the gradually changing part 34 is located in the middle tube 12.

Refer to FIG. 9, once the opening spring 3 with one gradually changing part 34 is assembled with the shaft 1 of a 4 fold automatic open-close umbrella having the first middle tube 12a and the second middle tube 12b, the gradually changing part 34 is located in the second middle tube 12b that is the outermost middle tube.

Refer to FIG. 11, when the opening spring 3 with two gradually changing parts 34a, 34b is used in a is assembled with the shaft 1 of a 4 fold automatic open-close umbrella having the first middle tube 12a and the second middle tube 12b, the upper gradually changing part 34a is located in the second middle tube 12b (the outermost middle tube) while the lower gradually changing part 34b is located in the first middle tube 12a. Moreover, the coil pitch of the above gradually changing parts 34, 34a, and 34b can be larger than or equal to the wire diameter d of the coil.

Due to the coil outer diameter of an upper part of the opening spring 3 larger than the coil outer diameter of a lower part of the opening spring 3, the space between the opening spring 3 and each tube 13, 12, 12a, 12b of the shaft 1 is reduced. The spring deformation is reduced while opening/closing the umbrella. Moreover, the deformation of the opening spring 3 is less than that of a conventional one-part opening spring 200. Thus the service life of the opening spring 3 is increased.

Besides 3 fold automatic open-close umbrella, the opening spring 3 of the present invention can also be applied to a multiple fold automatic open-close umbrella such as 4 fold automatic open-close umbrella or 5 fold automatic open-close umbrella. When the automatic open-close umbrella is 4 fold or 5 fold, there are at least two middle tubes 12a, 12b of the shaft 1. The middle tubes are sleeved to each other from the center to the outermost slidably. When the opening spring 3 is 3-part/segment or above and including at least two gradually changing parts 34, the gradually changing parts 34 from top to bottom are arranged in the middle tubes 12 (12a, 12b . . . ) from the outermost to the center correspondingly.

When manufacturers have special requirements in specification or functions, they can modify the outer diameter, the wire diameter, the pitch and the materials of the coil 33 of the opening spring 3 for providing the stroke and the spring constant required.

Refer to FIG. 12, the line L1 represents the one-part opening spring 200 of a prior art while F1 is an opening force (for the umbrella) and F2 is a closing force. As to the line L2, it represents the opening spring 3 of the present invention while F1 is an opening force and F3 is a closing force. It is learned from the figure that the opening spring 3 of the present invention uses coils 34 with a smaller wire diameter for providing the same elastic opening force as the one-part opening spring 200 yet with smaller closing force. Thus the total length of the opening spring 3 is increased. Moreover, a cross section of the above embodiments of the opening spring 3 according to the present invention is a circle, but not limited 1e, but not limited to. The cross section can also be oval (not shown in figure).

In summary, compared with conventional automatic open-close umbrellas, the opening spring 3 of the present invention has more simple structure so that the manufacturing is easier, the cost is reduced and the maintenance is more convenient. The structure of the opening spring 3 is an integrated spring having multiple segments. Thus the elastic force each segment/part needed is smaller than the elastic force of the conventional one-part opening spring. Thus a smaller force is required to slide the shaft while closing the umbrella. And the lateral deformation of the opening spring 3 is smaller than the lateral deformation of the conventional one-part opening spring 200 so that the service life of the opening spring 3 is increased.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An opening spring used for multiple fold automatic open-close umbrellas and disposed in a shaft of a multiple fold automatic open-close umbrella to provide power for extending the shaft while opening the multiple fold automatic open-close umbrella comprising: a plurality of segments of coils with different coil outer diameters formed by a wound wire with a constant wire diameter; and a gradually changing part arranged between two adjacent segments of coils;
wherein an outer diameter of an upper segment of coils of the two adjacent segments of coils is larger than an outer diameter of a lower segment of coils of the two adjacent segments of coils;
wherein an outer diameter of each coil of the gradually changing part is decreased axially from top to bottom.

2. The device as claimed in claim 1, wherein two adjacent coils in the coils of the gradually changing part of the opening spring are axially compressed or axially against each other when an outer diameter of a lower coil of the two adjacent coils is between an inner diameter and an outer diameter of an upper coil of the two adjacent coils.

3. The device as claimed in claim 1, wherein two adjacent coils in the coils of the gradually changing part of the opening spring are axially compressed each other without radial interference when an outer diameter of a lower coil of the two adjacent coils is smaller than an inner diameter of an upper coil of the two adjacent coils.

4. The device as claimed in claim 1, wherein a pitch of the upper segment of coils is larger than a pitch of a lower segment of coils of the opening spring.

5. The device as claimed in claim 1, wherein the opening spring includes an upper spring and a lower spring in turn from top to bottom while a gradually changing part is arranged between the upper spring and the lower spring; a bottom end of the upper spring is connected to a top end of the lower spring by the gradually changing part.

6. The device as claimed in claim 1, wherein the opening spring includes an upper spring, a middle spring, and a lower spring in turn from top to bottom; a gradually changing part is arranged between the upper spring and the middle spring and the other gradually changing part is disposed between the middle spring and the lower spring.

7. The device as claimed in claim 1, wherein a pitch of the coil of the gradually changing part is larger or equal to the wire diameter.

8. The device as claimed in claim 5, wherein a pitch of the coil of the gradually changing part is larger or equal to the wire diameter.

9. The device as claimed in claim 6, wherein a pitch of the coil of the gradually changing part is larger or equal to the wire diameter.

10. The device as claimed in claim 1, wherein the multiple fold automatic open-close umbrella comprising:
a shaft having an inner tube whose bottom is connected to an umbrella handle, at least one middle tube that is slid vertically around and engaged with the inner tube, and an outer tube slid vertically around and engaged with the middle tube while a top end of the outer tube is disposed with an upper runner;
an umbrella rib assembly having a top rib whose inner end is pivotally connected to the upper runner of the shaft, a lower branch rib that is pivotally connected to the top rib and an inner end of the lower branch rib is pivotally connected to a lower runner so as to be slid around and engaged with the outer tube of the shaft, and a plurality of umbrella ribs that are pivotally connected to one another, the top rib and the lower branch rib;
a plurality of closing springs each of which is disposed between the top rib and the lower branch rib of the umbrella rib assembly; and
a control mechanism having a button arranged at the umbrella handle;
the lower runner, the inner tube and the outer tube of the shaft, and each of the umbrella ribs of the umbrella rib assembly are extended upward and outward by pressing the button due to elasticity of the opening spring 3;
wherein a bottom end of the opening spring is arranged at and supported by a lower part of the inner tube of the shaft while a top end of the opening spring is against a bottom of the upper runner.

11. The device as claimed in claim 10, wherein the gradually changing part of the opening spring is in the middle tube when there is one middle tube of the shaft.

12. The device as claimed in claim 10, wherein a second middle tube is slid upward around and engaged with a first middle tube and the gradually changing part of the opening spring is in the second middle tube when there are two middle tubes of the shaft.
